(19) United States
(12) Patent Application Publication
(10) Pub. No.: US 2013/0208940 A1
(43) Pub. Date: Aug. 15, 2013

(54) HEADSET WITH PIVOTAL PARTS

(71) Applicants: Dennis W. Hansen, Solrod Strand (DK); Anders Koefoed, Kobenhavn N (DK); Jeppe M. Ørstad, Solrod Strand (DK)

(72) Inventors: Dennis W. Hansen, Solrod Strand (DK); Anders Koefoed, Kobenhavn N (DK); Jeppe M. Ørstad, Solrod Strand (DK)

(73) Assignee: SENNHEISER COMMUNICATIONS A/S, Solrod Strand (DK)

(21) Appl. No.: 13/839,338

(22) Filed: Mar. 15, 2013

Related U.S. Application Data
(62) Division of application No. 11/635,073, filed on Dec. 7, 2006.

(30) Foreign Application Priority Data
Dec. 4, 2006 (EP) 06 125 355.5

(51) Int. Cl. H04R 1/10

(52) U.S. Cl. CPC H04R 1/1066
USPC 381/384

(57) ABSTRACT

The invention concerns a communication device for placement at the ear of a user. A battery and transmission part is shaped to rest behind and above the ear lobe of a user and a speaker and microphone part is arranged to extend downwards in front of the ear canal. The two parts are interlinked to pivot, at least in the sagittal plane, with respect to each other and the battery and transmission part accommodates a battery as well as signal processing and transmission electronics, and the speaker and microphone part accommodates a speaker element and a microphone boom arm and further, the two parts have mating surfaces such that a pivotal motion between the two, when the device is not at the ear, will bring a surface of the first part and a surface of the second part together. Further the link between the two parts comprises a hollow ball joint connection allowing leads to pass through the ball joint. Also a magnet is inserted in the one part and a sensor for sensing the magnetic field from the magnet is comprised in the other part, such that the movement between the two parts may be registered and used to control the function of the device or for giving audible indication signals to the user.

### AREA OF THE INVENTION

The invention regards communication devices for placement onto the ear of a user. Such devices today comprise hearing aids and headsets. Hearing aids and headsets may be wired or wireless and the devices usually comprise at least one microphone which converts sound signals in the environment to electrical signals to be processed in the device. Further an output transducer, usually a speaker is provided in the device for transmitting an audio signal to the user. In hearing aids the audio signal presented to the user is the signal picked up by the microphone and which is currently present in the surroundings. In headsets the microphone is primarily used to pick up the voice signal of the user on order to transmit this signal to the telephone at the other end of the line, and the speaker presents the signal from the microphone of this telephone.

### BACKGROUND OF THE INVENTION

In us D 468,728 a headset is disclosed wherein two casing parts are provided: a behind the ear part and a speaker and boom part. The two casing parts are pivotally interlinked such that the speaker and boom part may be pivoted to bring the speaker in position outside the ear canal of the user. The boom part holds at its tip a microphone which at this movement will be positioned closer to the mouth of the user. This device may work fine, but it is not handy and the behind the ear part and the speaker and microphone part are not foldable to allow easy placement of the device in a pocket or the like. Further, the device in the D468728 document does not in any easy way allow the device to be moved from one ear to the other of the user.

A headset is desired, which is so compact as to easily fit into the pocket of a user and any boom arm should not protrude from the apparatus when folded together. Further, a headset is desired, which allows both rotational and pivotal movement between parts, wherein further the possible wires interconnecting parts remain invisible without causing overly big joint parts. Further, it is desired to produce a headset whereby a clear signal from the user's mouth is obtained without having to extend the boom arm to the area in front of the user's mouth.

Further, a ball joint connection which is both small and which allows electric leads to pass through the centre portion thereof is desired.

Further, a headset is desired, which has as few external switches or the like and which will automatically be activated when placed in the right position by the user.

### SUMMARY OF THE INVENTION

In a first aspect of the invention a communication device is provided with two interlinked parts arranged to be folded to lye alongside each other in close relation ship when the headset is not in use. Accordingly a communication device for placement at the ear of a user is provided which comprises a battery and transmission part shaped to rest behind and above the ear lobe of a user, and a speaker and microphone part arranged to extend downwards in front of the ear canal, wherein the two parts are interlinked to pivot, at least in the sagittal plane, with respect to each other, wherein the battery and transmission part accommodates a battery, a signal processor and transmission electronics, and the speaker and microphone part accommodates a speaker element and a microphone boom arm and, whereby the two parts have mating surfaces such that a pivotal motion between the two, when the device is not at the ear, will bring a surface of the first part and a surface of the second part together along a line.

The mating surfaces of the two housing parts allow the device to be folded into a compact unit in pocket knife fashion, where the mating surface parts are aligned. With the two housing parts folded together in this way the unit is very compact and may easily fit into the pocket of a user. Further this way of folding and un-folding the device is very simple and easy for the user to grasp, and does not require any lengthy instruction or previous education to understand.

In an embodiment the microphone boom arm extends away from the speaker and comprises two microphones whereby one microphone is placed distally and a further microphone is placed proximal with respect to the speaker.

When two microphones are placed apart from each other in this way a signal with very good signal to noise ration may be achieved through the processing of the signals from the two microphones. Thereby a very short boom-arm may be realized without compromising the signal to noise ratio obtainable by the device.

In an embodiment the signals from the two microphones are subject to array processing in the signal processor in order to gain a directional characteristic to achieve a clear voice signal from the user's mouth. Such a directional characteristic helps to ensure that only the users voice is picked up by the two microphones and thus a better signal to noise ratio is experience by the user at the other end of the line.

Preferably a damping or dampening material is supplied around the speaker and around the microphones inside the casing of the boom arm.

The close proximity between the proximal microphone and the speaker could in some cases be a problem, as the proximal microphone tends to pick up the speaker audio signal, and thereby cause feedback and noise in the telephone system. The dampening material ensure, that sound from the speaker is not propagated through the casing of the boom arm to reach the microphones.

In a preferred embodiment the pivotal link between the boom arm and the battery and transmission part is a ball joint allowing movement in the sagittal plane between the two parts as well as movement transversely with respect to this plane.

This function makes it easy and straight forward to position the loudspeaker in the correct position for radiating audio into the ear of the user. Also a ball joint connection allows rotation of the of the boom arm with respect to the battery and transmission part, and this makes it possible to point the boom arm in the direction of the mouth along the cheek of the user, and farther the rotation may easily be reversed if the headset is shifted to the opposite ear. The directional function of the boom arm is enhanced by the pointing of the arm in the direction of the mouth, and thus the two-microphone array and the ball joint in connection together ads to the signal to noise ration of the device.

In an embodiment the speaker is arranged to radiate sound towards two opposed directions transversely to the sagittal plane, such that the communication device is placeable at either of the two ears of a user. The advantage here is that movement from side to side can be done nearly instantaneous without any further ado, by simply placing the communication device on the opposite ear. Also movement from one person to another is easy as the headset is at any time ready for placement at any side of the head.

In an embodiment a knob is placed between the two microphones for working a switch in order to provide control signals to the communication device. Such a knob is very handy and easy to operate and it is especially an advantage that the user may operate the headset hereby without having to extend his hand to a position above his ear.

In an embodiment the ball joint connection provided between the battery and transmission part and the speaker and microphone part is hollow to allow electric leads to pass through the centre thereof between the two parts of the communication device. Passing the lead through the centre of the ball joint ensures that the leads are only pulled minimally at when angulation and/or rotation between the boom arm and the battery and transmission part is performed.

In an embodiment of the invention the ball joint connection comprises a ball 10, a spherical member 11 and a spring 12 whereby the spring 12 is placed inside the ball 10 and the ball 10 is placed inside the spherical member 11, and whereby the ball 10 is connected to one of the housing parts of the communication device and the spherical member 11 is connected to the other housing part. This construction of the ball joint connection allows the central part thereof to be hollow and at the same time ensures a stable and long lasting fictional force against movement of the joint parts. The friction is very important, as it is desired that once the joint is moved, it should remain in the new position and not without the users direct action change position.

In a further aspect of the invention a communication device for placement at the ear of a user is provided comprising a battery and transmission part shaped to rest behind and above the ear lobe of a user, and a speaker and microphone part arranged to extend downwards in front of the ear canal, wherein the two parts are interlinked to pivot, at least in the sagittal plane, with respect to each other, wherein the battery and transmission part accommodates a battery as well as signal processing and transmission electronics, and the speaker and microphone part accommodates a speaker element and a microphone boom arm and, whereby the microphone boom arm extends away from the speaker and comprises two microphones such that one microphone is placed distally and a further microphone is placed proximal with respect to the speaker.

In prior art devices of this kind only one microphone is used and this microphone is placed close to the mouth at the end of a long boom-arm. Shorter boom-arms accommodating a directional microphone are also known, but these are not effective in removing the noise radiated from the speaker and from other noise sources and a sufficiently clear and noise free signal from the uses mouth is usually not obtained. Accommodating the microphone boom and the speaker in the same housing allows a very compact design of the device, but only with two microphones does it become possible to effectively block the noise from the speaker from corrupting the obtained signal from the mouth.

In an embodiment sound damping material is provided in the speaker and microphone part at least adjacently to the speaker and the microphones.

Such a damping material will aid to block sound from the speaker, such that this sound does not propagate through the microphone and speaker housing and enters the microphones.

In an embodiment the signals from the two microphones are subject to array processing in a signal processing unit in order to provide a directional characteristic from of the microphone signals.

Array processing allows the possible noise signal from the speaker unit to be removed from the microphone signal and at the same time it allows a very short boom arm to be realized without compromising signal to noise ratio and thereby allows the headset to be very compact.

In an embodiment a switch with an externally provided knob is arranged in connection with the boom arm such that the knob is placed in the area between the two microphones.

In this area the knob and switch may be provided without causing any un-due extension of the boom arm length. Further, in this place the knob will be readily accessible for the user, when the communication device is placed at the ear.

In a further embodiment the battery and transmission part and a speaker and microphone part are interlinked to pivot by means of a ball joint connection whereby the ball joint connection is made with a hollow central part.

A ball joint connection is preferred for this link, as it will allow the boom arm to be adjusted to any side an also to be rotated, which is most important especially when the user wishes to shift the communication device from one to the other ear. However, at the same time it is most important that the construction of a ball joint is made such that it may accommodate the communication lines between the boom arm and the battery and transmission part. According to the invention it is thus proposed to make a hollow ball joint connection which allows leads to run through the centre thereof. Hereby a very compact and at the same time flexible unit is provided.

In an embodiment the communication device is made with a speaker which is provided to radiate sound in two opposed directions transversely to the sagittal plane.

This, along with the ball joint connection allows a very simple and easy shift of the communication device from one ear to the other. The speaker need not be moved or shifted as in prior art headsets and the ball joint makes it very straight forward to redirect the boom arm towards the mouth after shifting the device to the other ear.

In an embodiment of the invention, an external side of the microphone boom arm opposite the battery and connection part is convex curved and an external side of the battery and connection part opposite the boom arm is concave curved whereby the convex and concave curved sides will extend along one another along a line when the boom arm and battery and connection parts are collapsed by means of the ball joint connection.

As the two sides mentioned above have corresponding curves, the collapsed headset will take up a minimum of space and will thus easily fit into a pocket. Further, this construction ensures that no appendices protrude from the headset when it is collapsed which facilitate both withdrawal from and insertion into a pocket of a user.

In an embodiment of the invention a magnet is provided in the boom arm proximal to the convex curved side and a magnet sensitive switch is provided in the battery and connection part proximal the concave curved side in a position opposite the magnet. This allows the headset to activate automatically when the boom arm is moved away from the battery and connection part. Also it allows other functions to be activated, such as a light or audio signal to allow the user to gain visual or audio information about the proper function of the headset. Also turning off the headset may be performed by means of the magnet and switch combination.

In a further aspect of the invention a ball joint connection is provided comprising a spherical outer member, a ball for placement inside the spherical member and a spring element for proving constant frictional force between the ball and the spherical member whereby the spring element is hollow and arranged inside the ball in order to provide a passage through the ball joint connection. Such a ball joint connection can be made very compact and at the same time it will allow a number of leads to pass through the centre thereof. Passing the leads through the centre of the ball joint connection aids to avoid that the leads get pulled at or squeezed during movement of the ball joint connection, and at the same time it allows an agreeable look of the device to be provided where the leads remain in-visible from the outside.

Preferably the ball is integrally shaped with a socket part, and at least one slit is provided through the thickness of the ball from the top to the area of the socket part and preferably four slits are provided dividing the ball into four quarters each connected to the socket part.

The slits in the ball allows the sections of the ball to move resiliently such that the spring may ensure compression force between the ball and the spherical part.

In a further embodiment of the ball joint connection the spring element is shaped as a hollow tube section with a slit provided along the length thereof, such that the tube may be slightly compressed in the circumferential direction when placed inside the ball. This construction of the spring will ensure that at all times a sufficiently high compression force is provided between the ball and the special member with out the spring being subject to the risk of fatigue. Further, a large opening in the centre of the spring may be provided through this construction.

In a further embodiment the spherical member has cut out portions which cooperate with the socket part to define the limitation of movement between the ball and the spherical member. The cut out portions will allow varying degree of movement in different directions such that the cut out portion may allow extensive pivotal action in one direction and limited pivotal movement in other directions.

In an embodiment the ball is connected to the first part of a communication device and the spherical member is connected to a second part of a communication device, and further electric leads pass through the hollow spring element from the first to the second part of the communication device.

Hereby the ball joint connection will ensure that the two parts of the communication device are moveable with respect to each other whereby at the same time connection leads may pass from the one to the other part of the communication device an a safe way without creating large and bulky parts.

In a further aspect, the invention also comprises a headset with a battery and transmission part shaped to rest behind and above the ear lobe of a user. In this aspect of the invention further, a speaker and microphone part is arranged to extend downwards in front of the ear canal whereby the two parts are interlinked to pivot with respect to each other, and the battery and transmission part accommodates a battery as well as signal processing and transmission electronics, and the speaker and microphone part accommodates a speaker element and a microphone boom arm. The two parts have mating surfaces such that a pivotal motion between the two, when the device is not at the ear, will bring a surface of the first part and a surface of the second part together whereby a magnet is placed adjacently to one of the two mating surfaces, and a sensor responsive to the presence of a magnetic field is provided at the opposed mating surface such that the sensor will provide a signal indicative of the proximity between sensor and magnet and thus indicating that the two mating surface parts are either in close relationship or placed apart from each other.

By an arrangement of this nature, the simple action of folding or un-folding the two parts of the communication device may be registered by the sensor, and this event then can be used for either switching the communication device into a different state or for producing a sound through the speaker to be heard by the user or both. It is known to use a simple mechanical switch in connection with headsets to register the movement of parts relative to each other, but such a mechanical switch is bulky, and prone to failure, and further it is difficult to make such a switch in-visible. The present magnet and sensor can be made without any visual traces thereof and can also be made very fail-safe.

In an embodiment of the invention the signal from the sensor is used to trigger a change of state of the headset. This cooperates well with the user's usual desire that the headset is turned off when the two parts are folded together, and turned on or activated when the two parts are folded apart. In this way the user does not have to either switch off or turn on the headset, this is automatically done by the device when a folding/unfolding action is performed by the user.

In a further embodiment the signal produced by the sensor is used to trigger the generation of a sound signal by the speaker. Such a signal may alert the user to the fact that now the state of the headset has changed.

In a further embodiment a first sound signal is generated when the battery and transmission part is pivoted to lie along side the speaker and microphone part in order to signal a stand by condition or shut off action of the headset, and a second sound signal is generated when the battery and transmission part is pivoted away from the speaker and microphone part in order to signal an action of turning on or activating the headset. By providing different sound signals for the different actions, the user will always know what the current stat of the device is.

The artificial generation of sound for indicating the state of the apparatus allows the user to choose the sound he/she finds most appropriate from a library of sounds within or externally from the apparatus, or the user may choose to not have any sound generated.

### BRIEF DESCRIPTION OF THE DRAWINGS

FIG. 1 is a side view of an embodiment of the invention,

FIG. 2 is a view from the back of the headset shown in FIG. 1,

FIG. 3 is an exploded view of the speaker and microphone boom,

FIG. 4 is an exploded view of the ball-joint connection,

FIG. 5 is a detailed view of the ball join connection with cut away parts,

FIG. 6 is a computer graphical representation of the device in un-folded position, ready for placement on an ear of a user.

### DESCRIPTION OF A PREFERRED EMBODIMENT

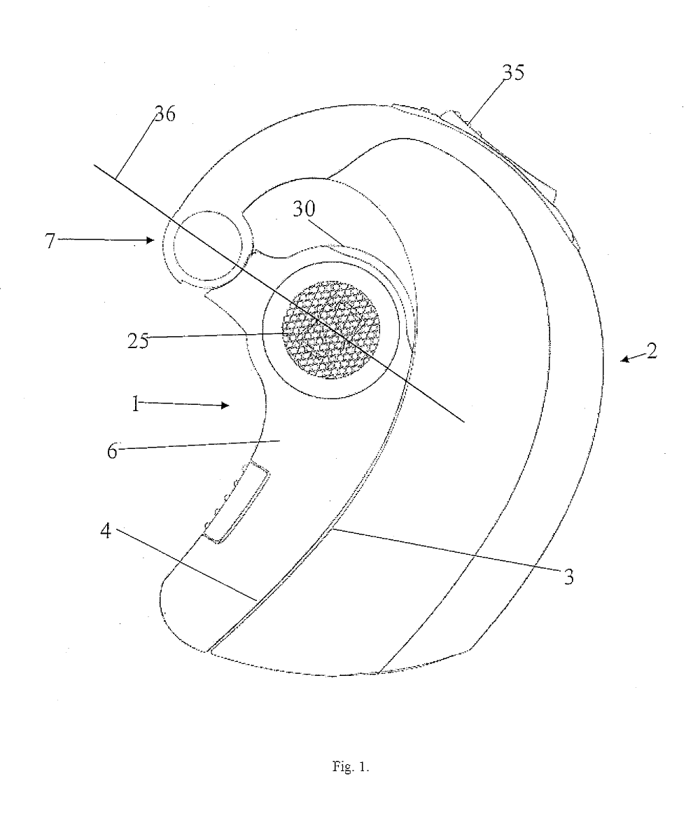

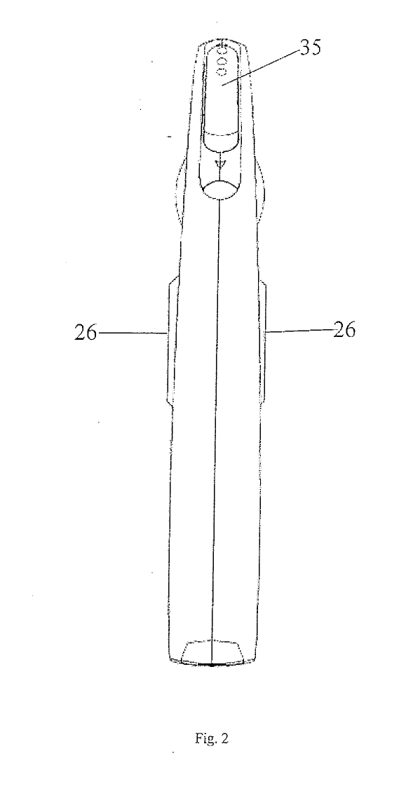

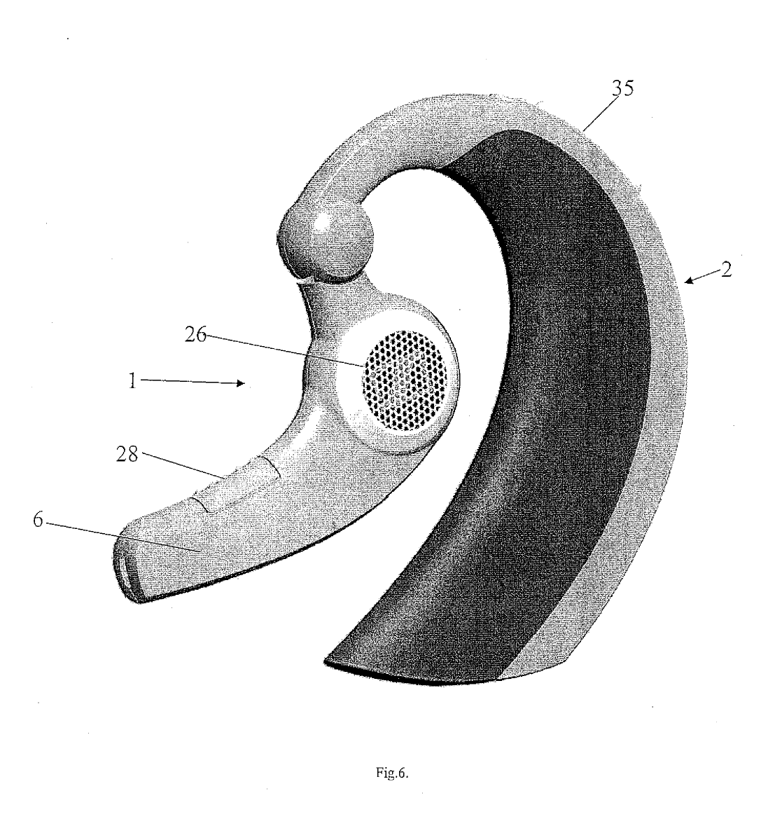

In FIGS. 1 and 6 a headset according to the invention is shown. The headset comprises two interlinked parts, a speaker and microphone part 1 and a battery and transmission part 2. The battery and transmission part 2 allows two way communication with a telephone or the like communication element. Preferably the communication link is a wireless blue-tooth link, but other kinds of communication links either wired or wireless may be provided. As seen in FIG. 2 both the battery and transmission part 2 and the speaker and microphone part 1 are made relatively flat, such that the battery and transmission part 2 will easily fit behind the ear lobe of a user, and the speaker and microphone part 1 will not protrude un-necessary in the sideway direction when the device is placed at the ear of a user.

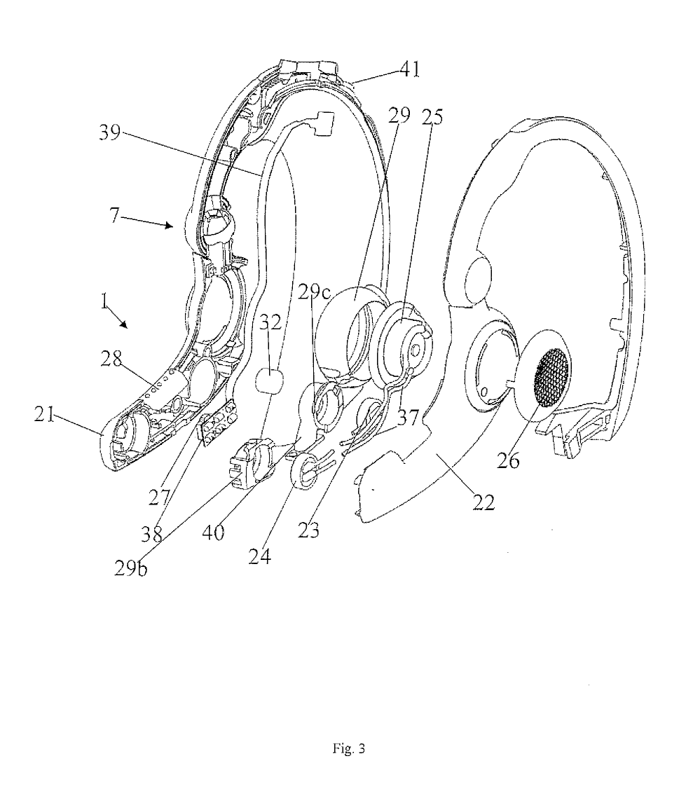

The battery and transmission part 2 and the speaker and microphone part 1 are connected in ball joint connection 7. The ball joint 7 will be placed at the top of the ear lobe and slightly in front of the ear in the face ward direction when the headset is placed on an ear. In order to place the device on the ear, the two parts are swung apart, the battery and communication part 2 is placed behind the ear lobe and the speaker and microphone part 1 is pressed lightly backward in order to gently pinch the ear lobe between the two parts. Hereby the speaker 5 will come to rest right outside the ear canal opening and the microphone boom arm 6, which extends from the housing of the speaker 25, will come to point in the direction of the mouth. A soft cushion part 30 is provided at the speaker 25 for soft rest of the casing against the inside portion of the ear lobe when the battery and transmission part 2 and the speaker and microphone part 1 are pinched together to gain hold of an external ear of a user. As seen in FIG. 3 the soft cushion part 30 is formed integrally with the damping material 29 provided around the speaker 25 such that the cushion part 30 may extend through suitable openings in casing part 21, 22 of the speaker and microphone part 1.

As seen in FIG. 1 the two interlinked parts of the headset have mating surfaces 3,4 such that when the device is not worn on the ear, they can be collapsed to lie alongside each other as shown in FIG. 1. The underside 3 of the battery and transmission part 2 has the same concave curvature as the convex curvature of the lower side 4 of the speaker and microphone part 1. This allows the headset to be collapsed to the position shown in FIG. 1 wherein the two sides 3,4 follow one another in a close parallel relationship and thereby the headset will fit into a pocket of an individual when not in use.

The speaker and microphone part 1 encloses a speaker 5 and two microphones 23-24 which are arranged in boom-arm 6. The microphone boom-arm 6 extends lengthwise away from the speaker 25 at nearly a right angle with respect to the axis 36 extending through the ball-joint connection 7 and the centre of the speaker 25. Having the ball joint 7 placed at the upper part and slightly in front of the ear will, along with the angled relationship between the boom-arm 6 and the axis 36, ensure the positioning of the speaker 25 in front of the ear and the direction of boom-arm 6 towards the mouth when the device is placed at the ear for use.

As seen in FIG. 2 the speaker 25 has two sound ports which are pointed in opposed directions. This allows the one and same headset to be used at either side of the head without any further ado. The headset is simply shifted to the other ear, if the user desires. The sound coming from the speaker 25 will not be audible to third parties unless he or she is standing very close by.

At the top if the battery and transmission part a toggle switch 35 is provided, for regulating the loudness of the sound from the speaker.

In order to assure a better fit of the headset to the shape of the users head the ball joint connection 7 is provided such that pivotal movement of the battery and transmission part 2 with respect to the speaker and microphone part 1 is allowed in the transverse direction and also rotational movement between the two is facilitated by the ball joint connection. 7.

Ball Joint Connection:

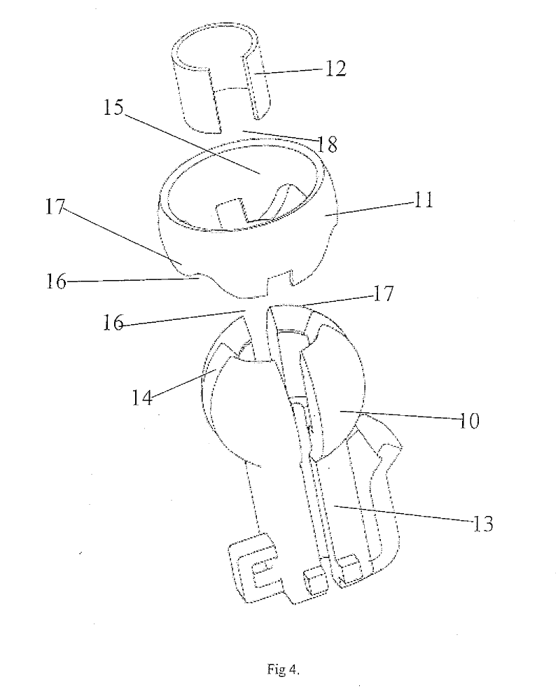

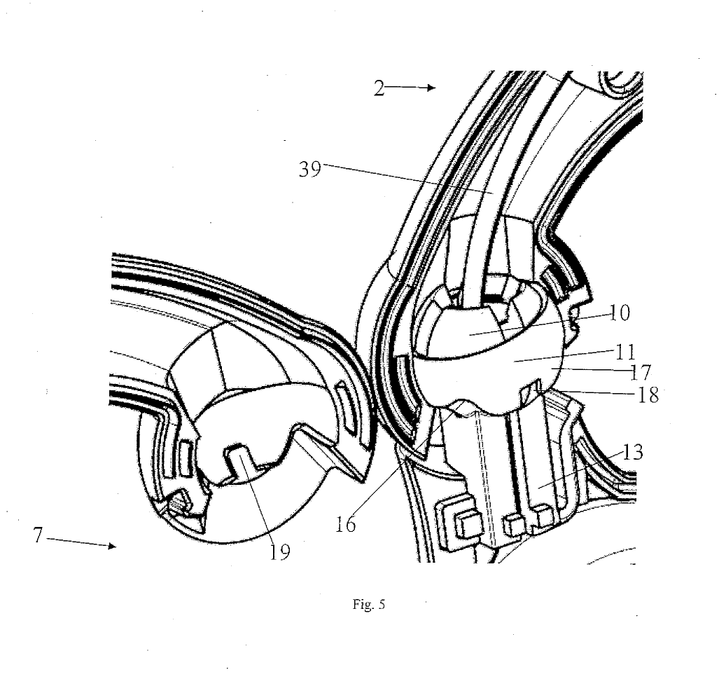

The ball joint connection 7 is described in the following with reference to FIGS. 4 and 5, where FIG. 4 shows an exploded view of the ball joint 7 and FIG. 5 shows a sectional elevated view, wherein the cut away portion is shown to the side of the actual ball joint. The joint comprise three basic elements: a split ball 10, a spherical member 11 and a spring 12. The split ball 10 is formed integrally with a socket 13. Once assembled the spring 12 is placed inside the split ball 10, and the ball 10 is placed inside the spherical member 11. Hereby rotational and pivotal movement between the spherical member 11 and the ball 10 is allowed. In the present embodiment the socket 13 is connected to the speaker and microphone part 1 and the spherical member 11 is connected to the top part of the battery and transmission part 2. In use it will be necessary to provide a wired connection between both the speaker 25 and microphones 23,24 and the battery and transmission part 2. Thus a number of wires (not shown in the drawings) have to run through the ball joint connection 7. The socket part 13 is thus hollow as are the spring 12 and the split ball 10 such that wires are allowed to pass through the ball joint 7 without hampering the movement of the ball joint parts.

The spring 12 serves to ensure constant frictional force between the split ball 10 and the spherical member 11 once the spring 12 is pressed into place inside the split ball 10. In the present embodiment the spring is shaped as a split hollow pipe element which is slightly compressed when placed inside the ball 10 in order to supply a constant force from the inside on the ball split parts of the ball 10. Other ways of shaping the spring may be provided such as a disk-shaped spring with a central opening, or the spring could have the shape of a screw line.

As seen, the split ball 10 is split in quarter parts by slits 14 traversing the wall of the ball 10, such that the four parts of the split ball 10 may be pressed outwardly against the internal spherical surface 15 of the spherical member 11 under the influence of the spring 12. The number of splits may vary from 1 to any reasonable number according to the size of the ball member. This construction is very compact and at the same time a number of wires (not shown) can to pass through the hollow socket part 13, the split ball 10 and the spring 12.

The spherical element 11 as seen in FIG. 4 has an internal spherical surface 15, corresponding to the surface of the split ball 10, and the spherical surface 15 extends in two opposed directions from a great circle. In the direction towards the socket part 13 of the split ball 10 the boarder of the spherical surface 15 limits the movement of the socket part 13 and together the lower boarder and the socket defines the movability between the split ball 10 and the spherical member 11. As seen in FIG. 4 the boarder of the spherical surface in the direction towards the socket 13 has cut out parts 16 which allow bigger pivotal movement of the split ball 10 in certain directions. Further, skirt regions 17 between the cut out parts 16 define, together with the socket part 13 the rotational movement allowable between the split ball 10 and the spherical member 11. In the embodiment shown in FIG. 4 only limited rotational movement between the split ball 10 and the spherical member is allowed. Thus in the communication device the speaker and microphone part 1 is only allowed limited rotational movement with respect to the battery and transmission part 2, but allows angular movement in the sagittal plane.

The ball joint connection allows the passage of wires or as in the embodiment shown a flexible printed circuit element 39 through the centre thereof, and at the same time the ball joint 7 can be made very compact. These advantages can be used in many places where ball joint connections are used.

As seen in FIG. 5 the spherical member 11 has sharp cut out parts 18 in the lower skirt 17 thereof. The cut out part 18 correspond to tabs 19 in the portion of the battery and transmission part 2 shaped to receive and immobilize the spherical member 11. In a similar way the socket 13 is maintained in the boom arm and fastened therein by taps and cut outs to ensure immobilization of the boom arm and socket part with respect to each other.

Boom-Arm Construction:

In FIG. 3 the speaker and microphone part 1 is shown in an exploded view. In the disclosed embodiment two shell elements 21, 22 are provided, which together forms an enclosure or hollow casing wherein proximal microphone 23, distal microphone 24 and the speaker 25 are accommodated. In each shell element a screen 26 is provided, such that sound may radiate there through and the speaker 25 remains protected behind the screens 26. Apart from the transducers mentioned, the casing also accommodate a switch 27, such that the user may change the function of the device by manipulating a knob 28 which will activate switch 27. For all of the electronic elements here mentioned electric wires 37 are provided, and all the wires 37 are connected to the printed circuit board 38. From the circuit board 38 a flexible printed circuit element 39 is provided, which passes through the ball joint connection 7 and gains contact with a larger printed circuit board enclosed in battery and connection part 2. In the exploded view of FIG. 3 the flexible printed circuit element is shown alongside the ball joint 7, but in the assembled apparatus the circuit element 39 is made to pass through the mid part of the ball joint 7 made hollow for this purpose. The switch 27 and knob 28 are placed between the two microphones 23, 24 and further the knob 28 is placed at the upper side for easy access for the user. The knob 28 is manoeuvred by a simple pinching action whereby the boom arm 6 is pinched from opposite sides by the user. As seen in FIG. 3 the knob 28 further has tactile markings making it easy to detect for the user that he has gripped the right portion of the boom arm 6 when he wants to activate the knob 28.

The speaker 25 is surrounded by sound and vibration damping material 29 and also distal microphone 24, is surrounded by a damper 29b and the proximal microphone 23 is surrounded by material 29c. The material surrounding the proximal microphone 23 is provided with a hollow tube or snout like portion 40 for guiding sound into the active microphone element. The snout portion 40 is provided such that the sound inlet of the snout portion 40 lies away from speaker 25. This ensures that the sound from the speaker does not enter the proximal microphone 23. Further, this material aids to prevent sounds from the speaker 25 to reach the microphones 23, 24 through the inside of the boom arm 1 and cause un-acceptable feedback levels when the device is used for telephone conversation.

Also in the boom-arm 1 a magnet 32 is inserted. This allows a simple sensor (not shown) provided in the battery and transmission part 2 to register when the boom arm 6 is placed adjacent to the battery and transmission part as shown in FIG. 1. This is usable for emitting a sound signal or for disconnecting the telephone line at the end of a conversation. The sound signal to be emitted could be a click, which would indicate to the user that a “hang up” or similar event has occurred caused by the folding together of the two parts of the headset. Also the magnet and sensor pair may be used to produce either a sound signal or a change of state in the headset when the two parts 1,2 are pivoted away from each other at the beginning of a telephone conversation. The sound signals may vary according to the change of function of the headset produced with the pivotal movement registered by the sensor. In an embodiment of the invention the magnet/sensor pair is used to register un-folding of the boom-arm, whereby such an un-folding action causes a light signal to be emitted from a diode in the battery and transmission part 2. A light guide with an exit opening 41 is provided in this connection such that the light signal is readily visible to the user, for indication that the headset is ready for use.

The two microphones placed inside the boom-arm 6 allow a directional characteristic to be obtained through signal processing in the transmission part, of the sound signal picked up by the microphones. Other types of signal processing drawing on the advantage of having two microphones may be employed such as special noise damping features.

When the boom-arm 6 is pointed towards the mouth a clear speech signal is achievable through this, even when the foremost microphone is not placed directly in front of the mouth.

1-17. (canceled)

18. A ball joint connection comprising:
a spherical outer member,
a ball for placement inside the spherical outer member, and
a spring element for providing constant frictional force between the ball and the spherical outer member, the spring element being hollow and arranged inside the ball in order to provide a passage through the ball joint connection.

19. The ball joint connection as claimed in claim 18, whereby the ball is integrally shaped with a socket part and where at least one slit is provided through a thickness of the ball from a top to an area of the socket part.

20. The ball joint connection as claimed in claim 19, whereby the spring element is shaped as a hollow tube section with a slit provided along a length thereof, such that the spring element may be slightly compressed in the circumferential direction when placed inside the ball.

21. The ball joint connection as claimed in claim 18, whereby the spherical member has cut out portions which cooperate with the socket part to define a limitation of movement between the ball and the spherical member.

22. The ball joint connection as claimed in claim 18, whereby the ball through the socket part is connected to a first part of a communication device and where the spherical member is connected to a second part of a communication device, and whereby electric leads pass through the hollow spring element from the first to the second part of the communication device.

23. The ball joint connection as claimed in claim 22, whereby the first part of the communication device comprises a microphone boom arm of a headset, and the second part of the communication device comprises a battery and transmission part of the headset.

24-28. (canceled)

29. The ball connection as claimed in claim 19, wherein the ball includes four slits connected to the socket part and dividing the ball into four quarters.
